(19) United States
(12) Patent Application Publication
(10) Pub. No.: US 2026/0088009 A1
(43) Pub. Date: Mar. 26, 2026

(54) ELECTRONIC APPARATUS GENERATING PERSONALIZED SOUND AND CONTROL METHOD THEREOF

(71) Applicant: SAMSUNG ELECTRONICS CO., LTD., Suwon-si (KR)

(72) Inventors: Jinhee PYUN, Suwon-si (KR); Donghyun KIM, Suwon-si (KR)

(73) Assignee: SAMSUNG ELECTRONICS CO., LTD., Suwon-si (KR)

(21) Appl. No.: 19/392,943

(22) Filed: Nov. 18, 2025

Related U.S. Application Data
(63) Continuation of application No. PCT/KR2025/010815, filed on Jul. 22, 2025.

(30) Foreign Application Priority Data
Sep. 26, 2024 (KR) 10-2024-0131118

(51) Int. Cl. G10H 1/00

(52) U.S. Cl. CPC G10H 1/0025; G10H 2210/031; G10H 2210/111

(57) ABSTRACT

An electronic apparatus includes at least one processor, and memory storing at least one instruction, wherein the at least one instruction, when executed by the at least one processor individually or collectively, cause the electronic apparatus to: obtain at least one parameter value corresponding to a characteristic of a sound, obtain a prompt to generate, based on the at least one parameter value, the sound in which the characteristic is reflected, obtain the sound by inputting the obtained prompt to an AI model, and transmit the obtained sound to at least one external apparatus.

### CROSS-REFERENCE TO RELATED APPLICATION

This application is a continuation application of International Patent Application No. PCT/KR2025/010815, filed on July 22, 2025, which claims priority from Korean Patent Application No. 10-2024-0131118, filed on September 26, 2024, in the Korean Intellectual Property Office, the disclosures of which are incorporated herein by reference in their entireties.

### BACKGROUND

### 1. Field

This disclosure relates to an electronic apparatus and a control method thereof, and particularly, to an electronic apparatus generating a personalized sound, and a control method thereof.

### 2. Description of Related Art

Internet of Things (IoT) devices may output a system sound such as a power beep indicating that a device is turned on or an operation beep indicating a notification or completion of an operation. Such IoT devices may generally output a uniform system sound. The uniform system sound results in a limitation of user experience and fails to satisfy user preferences.

Under the circumstances, there is a growing need for a personalized system sound that can enhance user experience. At a time when users want a system sound provided by an IoT device to be personalized according to their preferences, there is a need for a technology for providing a personalized system sound.

### SUMMARY

According to an aspect of the disclosure, an electronic apparatus comprising: at least one processor, and memory storing at least one instruction, wherein the at least one instruction, when executed by the at least one processor individually or collectively, cause the electronic apparatus to: obtain at least one parameter value corresponding to a characteristic of a sound, obtain a prompt to generate, based on the at least one parameter value, the sound in which the characteristic is reflected, obtain the sound by inputting the obtained prompt to an AI model, and transmit the obtained sound to at least one external apparatus.

The parameter value from among the at least one parameter value comprises a value based on at least one of a characteristic of an environment to which the sound is output, a vibe of the sound, a type of the sound, information on music preferred by a user, identification information corresponding to an external apparatus by which the sound is output, or an event to be sensed.

The at least one instruction, when executed by the at least one processor individually or collectively, causes the electronic apparatus further to: based on the event being sensed, transmit the obtained sound to the at least one external apparatus.

The at least one instruction, when executed by the at least one processor individually or collectively, causes the electronic apparatus to: obtain, from a music application executed in an external apparatus, the information on music preferred by the user.

The at least one instruction, when executed by the at least one processor individually or collectively, causes the electronic apparatus to: obtain a feature vector of music preferred by the user based on the information on music preferred by the user, and obtain the sound by inputting the prompt and the feature vector of music preferred by the user to the AI model.

The at least one instruction, when executed by the at least one processor individually or collectively, causes the electronic apparatus to: obtain a plurality of sounds in which the characteristic is reflected, determine a similarity score between a feature vector of each of the plurality of sounds and a feature vector corresponding to a situation of a user, identify a sound from the plurality of sounds having a highest similarity score, and transmit the identified sound to the at least one of external apparatus.

The at least one instruction, when executed by the at least one processor individually or collectively, causes the electronic apparatus to: obtain the sound by removing a noise from data based on a Gaussian distribution.

The at least one instruction, when executed by the at least one processor individually or collectively, causes the electronic apparatus to: obtain information on speaker performance of a plurality of external apparatuses, and transmit the obtained sound to an external apparatus of which speaker performance is greater than speaker performance of the other external apparatuses.

The at least one instruction, when executed by the at least one processor individually or collectively, causes the electronic apparatus to: based on a condition for outputting the obtained sound being satisfied, transmit the obtained sound to the at least one external apparatus among a plurality of external apparatuses, the at least one external apparatus being placed in a space in which a terminal apparatus of a user is placed.

According to an aspect of the disclosure, a control method of an electronic apparatus, the method comprising: obtaining at least one parameter value corresponding to a characteristic of a sound, obtaining a prompt to generate, based on the at least one parameter value, the sound in which the characteristic is reflected, obtaining the sound by inputting the obtained prompt to an AI model, and transmitting the obtained sound to at least one external apparatus.

The parameter value from among the at least one parameter value comprises a value based on at least one of a characteristic of an environment to which the sound is output, a vibe of the sound, a type of the sound, information on music preferred by a user, identification information corresponding to an external apparatus by which the sound is output, or an event to be sensed.

The transmitting the obtained sound to at least one external apparatus includes, based on the event being sensed, transmitting the obtained sound to the at least one external apparatus.

The obtaining at least one parameter value corresponding to a characteristic of a sound includes obtaining, from a music application executed in an external apparatus, the information on music preferred by the user.

The method further comprises: obtaining a feature vector of music preferred by the user based on the information on music preferred by the user, and wherein the obtaining a sound includes obtaining the sound by inputting the prompt and the feature vector of music preferred by the user to the AI model.

The obtaining a sound includes obtaining a plurality of sounds in which the characteristic is reflected, wherein the method further comprises: determining a similarity score between a feature vector of each of the plurality of sounds and a feature vector corresponding to a situation of a user, and identifying a sound from the plurality of sounds having a highest similarity score, and wherein the transmitting the obtained sound to the external apparatus includes transmitting the identified sound to the at least one of external apparatus.

According to an aspect of the disclosure, a non-transitory computer readable medium having instructions stored therein, which when executed by a processor in an electronic apparatus, cause the processor to execute a method comprising: obtaining at least one parameter value corresponding to a characteristic of a sound, obtaining a prompt to generate, based on the at least one parameter value, the sound in which the characteristic is reflected, obtaining the sound by inputting the obtained prompt to an AI model, and transmitting the obtained sound to at least one external apparatus.

The parameter value from among the at least one parameter value comprises a value based on at least one of a characteristic of an environment to which the sound is output, a vibe of the sound, a type of the sound, information on music preferred by a user, identification information corresponding to an external apparatus by which the sound is output, or an event to be sensed.

The transmitting the obtained sound to at least one external apparatus includes, based on the event being sensed, transmitting the obtained sound to the at least one external apparatus.

The obtaining at least one parameter value corresponding to a characteristic of a sound includes obtaining, from a music application executed in an external apparatus, the information on music preferred by the user.

The method further comprises: obtaining a feature vector of music preferred by the user based on the information on music preferred by the user, and wherein the obtaining a sound includes obtaining the sound by inputting the prompt and the feature vector of music preferred by the user to the AI model.

### BRIEF DESCRIPTION OF THE DRAWINGS

FIG. 1 is a view provided to explain a system generating a personalized sound according to one or more embodiments;

FIG. 2 is a block diagram provided to explain a configuration of an electronic apparatus according to one embodiment;

FIG. 3 is a block diagram provided to explain a configuration of a terminal apparatus according to one embodiment;

FIG. 4 is a block diagram provided to explain a configuration of an external apparatus according to one embodiment;

FIG. 5 is a sequence diagram provided to explain operations of an electronic apparatus, a terminal apparatus and an external apparatus according to one embodiment;

FIGS. 6-10 are views provided to explain how an electronic apparatus personalizes a sound according to one embodiment;

FIG. 11 is a view provided to explain how an electronic apparatus trains an artificial intelligence model according to one embodiment;

FIG. 12 is a view provided to explain a process of generating a sound by using an AI model according to one embodiment;

FIG. 13 is a sequence diagram provided to explain operations of an electronic apparatus, a terminal apparatus and an external apparatus according to one embodiment;

FIG. 14 is a sequence diagram provided to explain operations of an electronic apparatus, a terminal apparatus and an external apparatus according to one embodiment; and

FIG. 15 is a flowchart provided to explain a control method of an electronic apparatus according to one embodiment.

### DETAILED DESCRIPTION

Embodiments of the present disclosure may be modified in various different forms, and there may be various embodiments. Accordingly, specific embodiments are illustrated in drawings, and described in detail in the detailed description. However, it is to be understood that the embodiments are not intended to limit the scope of the disclosure to the specific ones but they are to be interpreted as including various modifications, equivalents and/or alternatives of embodiments set forth herein. In the drawings, like reference numerals may be used to indicate like elements.

In describing the disclosure, in case specific descriptions of known functions or configurations to which the disclosure pertains make the gist of the disclosure unnecessarily vague, detailed descriptions thereof are omitted.

Additionally, the embodiments described hereinafter may be modified in various different forms, and it is to be understood that the scope of the technical spirit of the disclosure is not limited to the embodiments. Rather, the embodiments are provided to make the disclosure thorough and complete and to fully convey the technical spirit of the disclosure to those skilled in the art.

Terms as used herein are merely used to describe a specific embodiment, and are not intended to limit the scope of the right that seeks protection. Unless explicitly stated otherwise, singular forms include plural forms as well.

In the disclosure, expressions such as “have,” “may have,” “include,” or “may include,” and the like are used to indicate the presence of a corresponding feature (e.g., elements such as a numerical value, a function, an operation, or a component and the like), and not exclude the presence of additional features.

In the disclosure, expressions such as “A or B,” “at least one of A or/and B,” or “one or more of A or/and B” may include all possible combinations of items listed together. For example, “A or B,” “at least one of A and B,” or “at least one of A or B” may refer to all cases including (1) at least one A, (2) at least one B, or (3) both of at least one A and at least one B.

In the disclosure, the expression “1st”, “2nd”, “first”, or “second”, and the like may be used to refer to various elements regardless of their order and/or importance, and may be used merely to differentiate one element from another but not be intended to limit the elements.

Based on one element (e.g., a first element) referred to as being “(operatively or communicatively) coupled with/to or connected with/to” another element (e.g., a second element), it is to be understood that one element may connect to another element directly, or through yet another element (e.g., a third element).

On the other hand, based on one element (e.g., a first element) referred to as being “directly coupled with/to” or “directly connected with/to” another element (e.g., a second element), it is to be understood that yet another element (e.g., a third element) is not present between one element and another element.

In the disclosure, the expression “configured to… (or set to)” used in the disclosure may be used interchangeably with, for example, “suitable for…,” “having the capacity to…,” “designed to…,” “adapted to…,” “made to…,” or “capable of…” depending on circumstances. The term “configured to… (or set to)” may not necessarily mean “specifically designed to” in terms of hardware.

Rather, in a certain situation, the expression “a device configured to…” may mean being capable of performing by the device together with another device or component. For example, the phrase “a processor configured (or set) to perform A, B and C” may mean an exclusive processor (e.g., an embedded processor) for performing the functions or a generic-purpose processor (e.g., a CPU or an application processor) capable of performing the functions by executing one or more software programs stored in a memory device.

In relation to the embodiments, the term “module” or “unit” may perform at least one function or operation, and be implemented by hardware or software or by a combination of hardware and software. Additionally, a plurality of “modules” or a plurality of “units” may be integrated into at least one module and be implemented as at least one processor except for a “module” or a “unit” that needs to be implemented by specific hardware.

Meanwhile, various elements and regions in the drawings are schematically illustrated. Accordingly, the technical spirit of the disclosure is not limited by relative sizes or distances illustrated in the accompanying drawings.

Hereinafter, embodiments according to the disclosure are described specifically with reference to the accompanying drawings such that those skilled in the art to which the disclosure pertains may readily implement the embodiments.

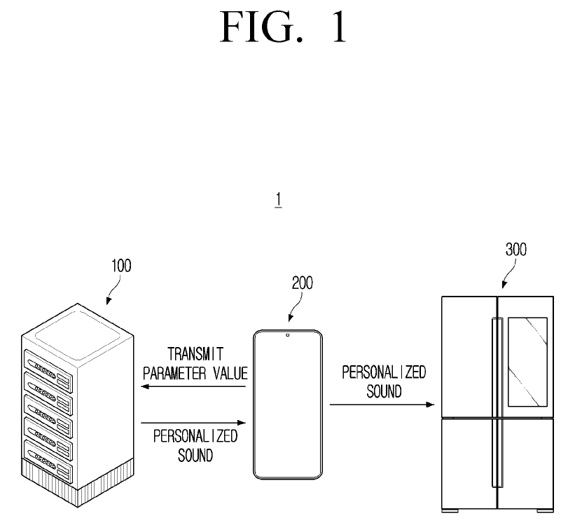

FIG. 1 is a view provided to explain a system generating a personalized sound according to one embodiment.

Referring to FIG. 1, a system 1 generating a personalized sound may include an electronic apparatus 100, a terminal apparatus 200, and an external apparatus 300.

According to one embodiment, the electronic apparatus 100 may be implemented as a server, the terminal apparatus 200 may be implemented as a smartphone, and the external apparatus 300 may be implemented as household appliances such as a refrigerator, a TV, a microwave oven and the like. The electronic apparatus 100 may communicate with the terminal apparatus 200 via network. As understood by one of ordinary skill in the art, the embodiments of the present disclosure are not limited to a single electronic apparatus 101. For example, the embodiments may be implemented on a distributed architecture that includes multiple processors. Furthermore, the embodiments may be implemented in which one or more tasks are split between a plurality of servers on a cloud.

In particular, the external apparatus 300 may be implemented as an Internet of Things (IoT) apparatus that may be connected to the Internet or a network and may receive and/or transmit data based on IoT technologies.

In one or more examples, the implementation example of each of the apparatuses described above may be described merely as one embodiment, and each of the apparatuses may be implemented in various different forms such as a server, a smartphone, a mobile phone, a TV, a smart TV, a set-top box, a refrigerator, a washing machine, a microwave oven, a dishwasher, a personal digital assistant (PDA), a laptop, a media player, an electronic book terminal, a digital broadcasting terminal, a navigator, a kiosk, an MP3 player, a wearable device, a home appliance and another mobile or non-mobile computing device and the like.

The external apparatus 300 may output a system sound to deliver an operation state of the external apparatus 300, an interaction through a user interface of the external apparatus 300, an alarm notification and the like to the user. The system sound may be used to display a state of the external apparatus 300 or to provide a feedback to the user when the user performs a specific task through the external apparatus 300. For example, in the case where the external apparatus 300 starts to operate, the external apparatus 300 may output a sound indicating that an operation starts. In one or more examples, the external apparatus 300 may output a confirmation sound in the case where a button is pressed. Alternatively, the external apparatus 300 may output a sound indicating that a specific operation is completed in the case where the specific operation is completed.

In the disclosure, the “system sound” of the external apparatus may be replaced with a term of an identical/similar concept such as an “output sound”, a “notification sound”, an “operation sound”, a “feedback sound”, a “signal sound”, a “function sound”, a “state sound”, an “alarm sound”, an “interface sound”, or a “control sound”. Furthermore, as understood by one or ordinary skill in the art, the embodiments are not limited to a system sound.” For example, the embodiments may also include haptic or visual feedback that is output with the “system sound,” or is output in lieu of the “system sound.”

The system 1 according to the disclosure may personalize the system sound of the external apparatus 300. The system 1 may generate a sound having a property preferred by the user and/or a property appropriate for a user environment by reflecting a user preference, a user environment and the like. For example, a user preference may specify a predetermined volume level, predetermined frequency range (e.g., high pitch or low pitch), or preferred language (e.g., English, Spanish, etc.).

The terminal apparatus 200 may drive an application for personalizing the system sound of the external apparatus 300. The terminal apparatus 200 may obtain a user input setting a parameter value for determining a property of the system sound through the driven application.

In the case where a parameter value is set, the terminal apparatus 200 may transmit the set parameter value to the electronic apparatus 100. At this time, the terminal apparatus 200 may transmit, to the electronic apparatus 100, a request for generating a personalized sound by using the parameter value.

Based on the received parameter value, the electronic apparatus 100 may obtain a prompt for generating a sound in which a determined property is reflected. The prompt may include information on a parameter value for determining a property of a sound.

The prompt may denote an input for starting an interaction with an AI model generating a personalized sound. The prompt may be a text input including one or more words and/or one or more sentences. In one or more examples, the prompt may be displayed in a graphical user interface on the terminal apparatus 300. The prompt may be displayed in response to executing an application that causes the prompt to be display. The prompt may include text or audio that requests the user to enter an input. The input may be text, or a selection of a choice from a plurality of choices.

When obtaining the prompt, the electronic apparatus 100 may obtain a sound in which a determined property is reflected, by inputting the obtained prompt to the AI model. The generated sound may be a sound having a property personalized for the user. The generated sound may be replaced with a term such as a “personalized sound” or an “AI sound”.

The AI model may be a generative AI model generating a sound personalized under a condition of the input prompt. As understood by one of ordinary skill in the art, a generative AI model may be a type of AI model configured to create new content, such as images, text, music, and audio, based on existing data. A generative AI model may learn from data and uses that knowledge to generate new samples or instances. Examples of generative AI models include, but are not limited to Generative Adversarial Networks (GANs) and Variational Autoencoders (VAEs).

The electronic apparatus 100 may transmit the obtained sound to the terminal apparatus 200. The terminal apparatus 200 may transmit the received sound to the external apparatus 300. The external apparatus 200 may output the received sound in the case where conditions for outputting the received sound are satisfied. In one or more examples, each of these apparatuses may be connected via near field communication technology such as Bluetooth, or may be connected via Wi-Fi or the Internet.

A configuration and a specific function of each element constituting the system 1 are described with reference to the drawings hereinafter.

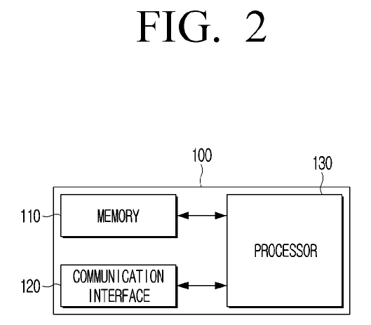

FIG. 2 is a block diagram provided to explain a configuration of an electronic apparatus according to one embodiment.

Referring to FIG. 2, the electronic apparatus 100 may include at least one of memory 110, a communication interface 120 and a processor 130. The electronic apparatus 100 may further include another element in addition to the above-described elements.

The memory 110 may store at least one instruction associated with the electronic apparatus 100. The memory 110 may store an operating system (O/S) for driving the electronic apparatus 100. Additionally, the memory 110 may store various types of software programs or applications for the electronic apparatus 100 to operate according to various embodiments of the disclosure. Further, the memory 110 may include semiconductor memory such as flash memory and the like, or a magnetic storage medium such as a hard disk and the like, and the like.

Specifically, the memory 110 may store various types of software modules for the electronic apparatus 100 to operate according to various embodiments of the disclosure, and the processor 130 may control operations of the electronic apparatus 100 by executing various types of software modules stored in the memory 110. That is, the memory 110 may be accessed by the processor 130, and reading/storing/correcting/deleting/updating and the like of data in the memory 110 may be performed by the processor 130.

Meanwhile, in the disclosure, the term memory 110 may be used in the way that the term memory 110 has a meaning including memory 110, ROM or RAM in the processor 130, or a memory card mounted in the electronic apparatus 100.

The communication interface 120 includes circuitry, and is an element communicable with an external apparatus and a server. The communication interface 120 may perform communication with an external device or a server based on a wired or wireless communication method. The communication interface 120 may include a Bluetooth module , a Wi-Fi module, an infrared (IR) module, a local area network (LAN) module, an Ethernet module and the like. Herein, each of the communication modules may be implemented in the form of at least one hardware chip. A wireless communication module may include at least one communication chip such as ZigBee, Universal Serial Bus (USB), Mobile Industry Processor Interface Camera Serial Interface (MIPI CSI), 3rd Generation (3G), 3rd Generation Partnership Project (3GPP), Long Term Evolution (LTE), LTE Advanced (LTE-A), 4th Generation (4G), 5th Generation (5G) and the like that perform communication according to various wireless communication standards in addition to the above-described communication methods. However, these are provided only as examples, and the communication interface 120 may use at least one of various types of communication modules.

The processor 130 may control entire operations and functions of the electronic apparatus 100. Specifically, the processor 130 may be connected to the configuration of the electronic apparatus 100 including the memory 110, and may control entire operations of the electronic apparatus 100 by executing at least one instruction stored in the memory 110 as described above.

The processor 130 may be implemented in various ways. For example, the processor 130 may be implemented as at least one of an application specific integrated circuit (ASIC), a logic integrated circuit, an embedded processor, a Micom, a microprocessor, hardware control logic, a hardware finite state machine (FSM), and a digital signal processor (DSP).

In particular, the processor 130 may include one or more processors. Specifically, the one or more processors may include one or more of a central processing unit (CPU), a graphics processing unit (GPU), an accelerated processing unit (APU), Many Integrated Core (MIC), a digital signal processor (DSP), a neural processing unit (NPU), a main processing unit (MPU), a hardware accelerator or a machine learning accelerator. The one or more processors may control one among other elements of the electronic apparatus or any combination thereof, and perform an operation associated with communication or data processing. The one or more processors may execute one or more programs or an instruction stored in the memory. For example, when the instructions stored in the memory 110 are executed by the one or more processors individually or collectively, the electronic apparatus 100 may perform operations according to the disclosure.

In the case where a method according to one or more embodiments of the disclosure includes a plurality of operations, the plurality of operations may be performed by one processor, or by a plurality of processors. That is, when a first operation, a second operation, and a third operation are performed based on the method according to one or more embodiments, the first operation, the second operation and the third operation may all be performed by a first processor, or the first operation and the second operation may be performed by the first processor (e.g., a generic-purpose processor), while the third operation may be performed by a second processor (e.g., an AI-exclusive processor).

The one or more processors may be implemented as a single core processor including one core, or one or more multicore processors including a plurality of cores (e.g., a homogeneous multi core or a heterogeneous multi core). In the case where the one or more processors are implemented as a multicore processor, each of the plurality of cores included in the multicore processor may include a processor internal memory such as cache memory, and on-chip memory, and common cache shared by the plurality of cores may be included in the multicore processor. Additionally, each of the plurality of cores (or part of the plurality of cores) included in the multicore processor may read and perform a program instruction for implementing the method according to one or more embodiments of the disclosure independently, or in the way that all (or part) of the plurality of cores are lined.

In the case where the method according to one or more embodiments of the disclosure includes a plurality of operations, the plurality of operations may be performed by one of the plurality of cores included in the multicore processor, or by the plurality of cores included in the multicore processor. For example, when a first operation, a second operation, and a third operation are performed based on the method according to one or more embodiments, the first operation, the second operation and the third operation may all be performed by a first core included in the multicore processor, or the first operation and the second operation may be performed by the first core included in the multicore processor, while the third operation may be performed by a second core included in the multicore processor.

In the embodiments of the disclosure, the processor 130 may denote a system on a chip (SoC) where one or more processors and other electronic components are integrated, a single core processor, a multicore processor, or a core included in a single core processor or a multicore processor, and herein, the core may be implemented as a CPU, a GPU, an APU, a MIC, a DSP, an NPU, a hardware accelerator, or a machine learning accelerator and the like, but the embodiment thereof may not be limited thereto.

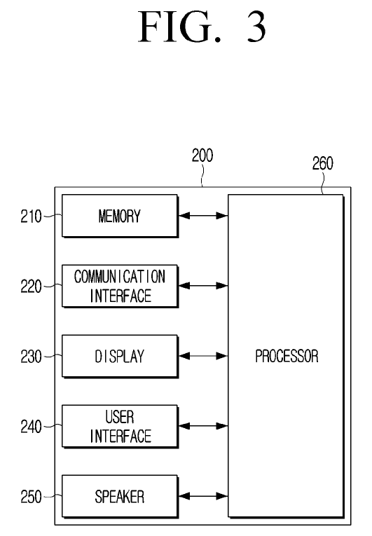

FIG. 3 is a block diagram provided to explain a configuration of a terminal apparatus according to one embodiment.

Referring to FIG. 3, the terminal apparatus 200 may include memory 210, a communication interface 220, a display 230, a user interface 240, a speaker 250, and a processor 260. Some of the elements may be omitted, and the terminal apparatus 200 may further include another element in addition to the above-described elements.

Meanwhile, in the configuration of the terminal apparatus 200 illustrated in FIG. 3, descriptions of the memory 210, the communication interface 220 and the processor 260 may overlap with those provided with reference to FIG. 2, and repetitive description thereof is avoided.

The display 230 may be implemented as various types of displays such as a liquid crystal display (LCD), an organic light emitting diode (OLED) display, a plasma display panel (PDP) and the like. In the display 230, driving circuitry, a backlight unit and the like that may be implemented in the form of an amorphous silicon thin film transistor (a-si TFT), a low temperature poly silicon (LTPS) TFT, an organic TFT (OTFT) and the like may be included together. Meanwhile, the display 230 may be implemented as a touch screen coupled with a touch sensor, a flexible display, a three-dimensional display (3D display) and the like. Additionally, the display 230 according to one embodiment may include a bezel housing a display panel as well as a display panel outputting an image. In particular, the bezel according to one embodiment may include a touch sensor for sensing a user interaction.

The user interface 240 may be implemented as a device such as a button, a touch pad, a mouse and a keyboard, or a touch screen that can perform the above-described display function and manipulation input function together. Herein, the button may be various types of buttons such as a mechanical button, a touch pad, a wheel and the like that are formed in any area such as a front, a side, a rear and the like of the exterior of the main body of the electronic apparatus 100.

The speaker 250 is an element for outputting an audio signal. In particular, the speaker 250 may include an audio output mixer, an audio signal processor, and a sound output module. The audio output mixer may synthesize a plurality of audio signals to be output into at least one audio signal. For example, the audio output mixer may synthesize an analogue audio signal and another analogue audio signal (e.g., an analogue audio signal received from the outside) into at least one analogue audio signal. The sound output module may include a speaker or an output terminal.

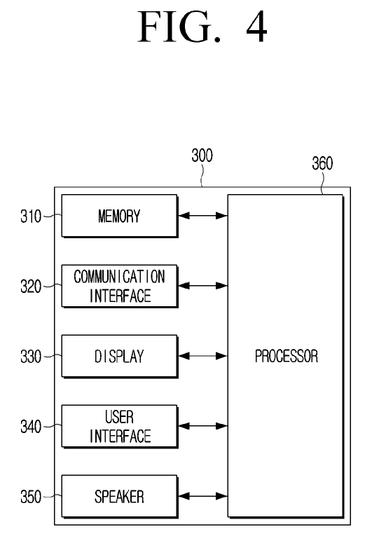

FIG. 4 is a block diagram provided to explain a configuration of an external apparatus 300 according to one embodiment.

Referring to FIG. 4, the external apparatus 300 may include memory 310, a communication interface 320, a display 330, a user interface 340, a speaker 350 and a processor 360. Some of the elements may be omitted, and the terminal apparatus 200 may further include another component in addition to the above-described elements.

Meanwhile, in the configuration of the external apparatus 300 illustrated in FIG. 4, descriptions of the memory 310, the communication interface 320, the display 330, the user interface 340, the speaker 350 and the processor 360 may overlap with those provided with reference to FIGS. 2 and 3, and repetitive description thereof is avoided.

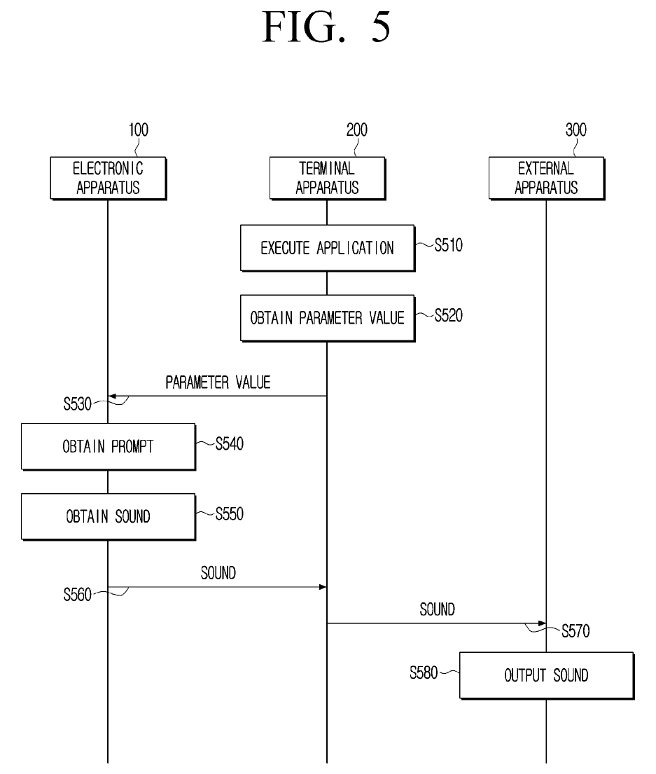

FIG. 5 is a sequence diagram provided to explain operations of an electronic apparatus, a terminal apparatus and an external apparatus according to one embodiment.

Referring to FIG. 5, when obtaining a user input for executing an application, the terminal apparatus 200 may execute the application (S510). The executed application may be an application installed in the terminal apparatus 200 to personalize a sound output by the external apparatus.

When the application is executed, the terminal apparatus 200 may obtain a user input setting a parameter value for determining a property (or characteristic) of a system sound of the external apparatus 300 (S520). For example, the application may be configured to display a prompt on the terminal apparatus 200 that requests the user to enter information corresponding to a parameter value.

The parameter value that can be set based on the user input may include a parameter value of at least one of an output environment of a sound, a mood of a sound, a type of a sound, music preferred by the user, and identification information of an external apparatus.

According to one or more embodiment, a parameter value from among the at least one parameter value may comprise a value based on at least one of a characteristic of an environment to which the sound is output, a vibe of the sound, a type of the sound, information on music preferred by a user, identification information corresponding to an external apparatus by which the sound is output, or an event to be sensed.

The output environment of a sound may denote an environment appropriate for outputting a personalized sound. That is, in the case where the output environment of a sound is set, the system 1 may generate a sound having a property appropriate for the output environment.

The output environment of a sound may include a continuous environment and a temporary environment. The continuous environment may denote a continuously maintained environment in the output environment of a sound. The temporary environment may denote a temporarily maintained environment in the output environment of a sound.

That is, the continuous environment may denote an environment in which a personalized sound needs to be reflected all the time each time the personalized sound is generated. The temporary environment may denote an environment in which the user needs to select whether to reflect a personalized sound each time a system sound of the external apparatus 300 is personalized. In one or more examples, the continuous environment may be a private space primarily used by the user or may be an environment in which the conditions of the environment rarely change. The temporary environment may be a public environment used my multiple people or may be an environment in which the conditions frequently change.

For example, in the output environment of a sound, a parameter value of the continuous environment may include at least one of “a baby being present”, “using together with an elderly person” and “residing in a house with bad soundproofing. As described above, at least one parameter value of the continuous environment may be selected, but this is described merely as one embodiment, and a parameter value of the continuous environment may not be selected.

For example, in the output environment of a sound, a parameter value of the temporary environment may include at least one of “a baby sleeping”, “using a household appliance at night”, and “being together with a guest”. As described above, at least one parameter value of the temporary environment may be selected, but this is described merely as one embodiment, and a parameter value of the temporary environment may not be selected.

When obtaining a user input setting a parameter value of the continuous environment, the terminal apparatus 200 may set a parameter value of the continuous environment to a default. The parameter value of the continuous environment, set to a default, may be reflected again each time a personalized sound is generated although the user does not set the parameter value of the continuous environment again.

The “continuous environment” may be replaced with a “normal environment”, a “normal state”, an “environment to be reflected all the time, and the temporary environment may be replaced with a “special environment”, a “special state” and an “environment to be reflected only this time”.

The mood (or vibe) of a sound may denote emotional feelings or sensual feelings that are generated or delivered by a sound. The mood of a sound may be determined based on a timbre, a rhythm, a volume, a harmony and the like associated with a sound, and arouse a particular feeling in a listener, or create a particular atmosphere.

For example, a parameter value of the mood of a sound, which may be set based on a user input, may include a least one of “colorful”, “romantic”, “hip”, “clean”, “calm”, “warm”, “mischievous”, “fancy”, “luxury”, “simple”, “rhythmical”, “refreshing”, “dignified”, “quiet”, “classic” and “fresh”.

Information on music preferred by the user may include at least one of a title of music preferred by the user, a singer preferred by the user, and a genre of music preferred by the user.

For example, a parameter value of music preferred by the user may be like “songs of singer A”, “B sung by singer A” or “classical music”.

The “music preferred by the user” may be replaced with “music set by the user”, “music designated by the user”, “music searched by the user”, “music listened to by the user frequently”, “music listened to by the user with a frequency greater than or equal to a determined frequency”, and the like.

The identification information of an external apparatus may include at least one of a model name, model number, type, function, and role and characteristic of an external apparatus. The system according to the disclosure may personalize a system sound of an external apparatus corresponding to selected identification information.

For example, a parameter value of the identification information of an external apparatus may be implemented as a type of an external apparatus such as a “washing machine”, a “refrigerator”, or a “TV”.

For example, the parameter value of the identification information of an external apparatus may be implemented as a product name such as a “Bespoke AI steam”, a “Bespoke Qooker oven”, or a “Bespoke AI WindFree Classic”.

According to one or more embodiment, the parameter value corresponding to a characteristic of the sound may include a parameter value based on the event to be sensed. The event to be sensed may refer to an event for transmitting the sound to an external device by the electronic apparatus 100. That is, when the electronic device 100 sense an event, the electronic apparatus 100 may transmit the acquired sound to the external device such that the external device outputs the acquired sound. The event to be sensed may also be referred to as a detected event, a trigger event, or the like.

Meanwhile, the terminal apparatus 200 may also obtain a parameter value that is not set by the user, by using a parameter value set by the user. Specifically, in the case where the identification information of an external apparatus is selected, the terminal apparatus 200 may obtain a parameter value of specification information of an external apparatus corresponding to the selected identification information. In one or more examples, the specification information of an external apparatus may be stored in the memory 210. The specification information of an external apparatus may include performance information of a speaker such as an output watt and an output channel of a speaker of an external apparatus. That is, in the case where the type or identification information of an external apparatus is set, the parameter value of the specification information of an external apparatus may be obtained although the parameter value of the specification information of an external apparatus is not set by the user.

The terminal apparatus 200 may display a UI for obtaining a user input setting a parameter value through an executed application on the display 230. The terminal apparatus 200 may obtain the user input setting a parameter value through the displayed UI.

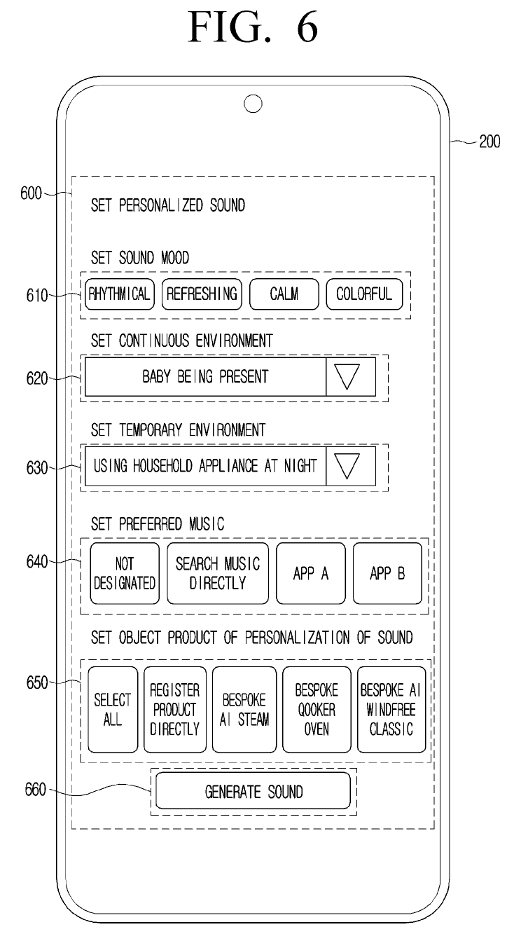

For example, a UI displayed by the terminal apparatus 200 may be like the one illustrated in FIG. 6. Referring to FIG. 6, a UI 600 displayed by the terminal apparatus 200 may include a UI element 610 for setting a parameter value of the mood of a sound, a UI element 620 for setting a parameter of the continuous environment in the output environment of a sound, a UI element 630 for setting a parameter value of the temporary environment in the output environment of a sound, a UI element 640 for setting a parameter value of music preferred by the user, a UI element 650 for selecting identification information of an external apparatus for personalizing a sound, and a UI element 660 for starting an operation for generating a personalized sound by using a set parameter value.

At this time, part of the displayed UI elements may be omitted, and the UI 600 may further include another UI element in addition to the above-described UI elements.

The UI element 640 for setting a parameter value of music preferred by the user may include an element of not selecting music preferred by the user, an element for enabling the user to search music preferred by the user, and an element for selecting a music appreciation application enabling the user to listen to music preferred by the user.

In the case where the element for enabling the user to search music preferred by the user is selected, the terminal apparatus 200 may display a UI for enabling the user to search music preferred by the user. Through the displayed UI, the terminal apparatus 200 may obtain information on music preferred by the user.

Alternatively, in the case where the element for selecting a music appreciation application enabling the user to listen to music preferred by the user is selected, the electronic apparatus 100 may obtain a parameter of music preferred by the user in link with the selected music appreciation application. At this time, the terminal apparatus 200 may display a UI for obtaining consent of the user for linking with the selected music appreciation application. In the case where the consent of the user is obtained through the displayed UI, the terminal apparatus 200 may obtain the parameter value of music preferred by the user in link with the music appreciation application.

The UI element 650 for selecting identification information of an external apparatus may include a list of external apparatuses in link with the terminal apparatus 200. An external apparatus in link with the terminal apparatus 200 may denote an apparatus connected with the terminal apparatus 200 through an identical home network. Alternatively, an external apparatus 300 in link with the terminal apparatus 200 may denote an apparatus that is performing a communication connection with the terminal apparatus 200. Alternatively, an external apparatus in link with the terminal apparatus 200 may denote an apparatus that is previously registered for a user account of the terminal apparatus 200, to which the user logs in. Alternatively, an external apparatus 300 in link with the terminal apparatus 200 may denote an apparatus that is registered with the terminal apparatus 200.

The terminal apparatus 200 may obtain a user input selecting at least one of a plurality of external apparatuses included in a displayed list. The terminal apparatus 200 may obtain a user input selecting at least one apparatus for personalizing a system sound among external apparatuses in link with the terminal apparatus 200 through a displayed UI element 650. A sound personalizing system according to the disclosure may personalize a system sound of an external apparatus corresponding to identification information selected by the user.

When obtaining a parameter value for determining a property of a sound, the terminal apparatus 200 may transmit the obtained parameter value to the electronic apparatus 100 (S530). That is, the electronic apparatus 100 may receive a parameter value set by the user from the terminal apparatus 200.

In one or more embodiments, the electronic apparatus 100 may obtain at least one parameter value corresponding to a characteristic of the sound. In one or more example, the electronic apparatus 100 may receive at least one parameter value corresponding to a characteristic of the sound from a terminal apparatus 200. In one or more example, the electronic apparatus 100 may obtain a parameter value that is not set by the user, by using a parameter value set by the user.

When receiving the parameter value for determining a property of a sound, the electronic apparatus 100 may obtain a prompt for generating a sound in which a determined property is reflected (S540).

According to one embodiment, the electronic apparatus 100 may generate a prompt according to a rule-based method. That is, the electronic apparatus 100 may generate a prompt by using a parameter value obtained according to a determined rule. However, generating a prompt according to a rule-based method is described merely as one embodiment, and a prompt may be generated by using another method. For example, the electronic apparatus 100 may generate a prompt by using an AI model trained for generating a prompt. That is, the electronic apparatus 100 may generate a prompt by inputting a parameter value to a trained AI model.

The electronic apparatus 100 may generate a prompt by inputting an obtained parameter value to a determined prompt format. The determined prompt format may include a plurality of input fields. The electronic apparatus 100 may generate a prompt by inputting an obtained parameter value to a format including the plurality of input fields.

For example, the determined prompt format may be in accordance with “a {Mood} {SoundType} system sound {Situation} {FavoriteMusic} for {Type} {Speaker Quality} speaker”. At this time, the input fields included in the determined prompt format may be {Mood}, {SoundType}, {Situation} {FavoriteMusic}, {Type} and {Speaker Quality}.

The electronic apparatus 100 may input a parameter value of a mood of a sound in the {Mood} field, in the determined prompt format. The electronic apparatus 100 may input a parameter value of a type of a sound set by the user in the {SoundType} field. The electronic apparatus 100 may input a parameter value of an environment set by the user in the {Situation} field. The electronic apparatus 100 may input a parameter value of a song preferred by the user in the {FavoriteMusic} field. The electronic apparatus 100 may input a parameter value of a type of an external apparatus set by the user in the {Type} field. The electronic apparatus 100 may input a parameter value of speaker performance of an external apparatus in the {Speaker Quality} field.

Meanwhile, a parameter value set by the user may differ from a parameter value input to an input field of the prompt. That is, the electronic apparatus 100 may convert a parameter value set by the user into a parameter value appropriate to be input to an input filed of the prompt. The electronic apparatus 100 may convert a parameter value set by the user into a parameter value in language and/or a form appropriate to be input to the AI model.

In one or more examples, a parameter value set by the user may be expressed in language A, while the AI model may be a model trained based on language B. In this case, the electronic apparatus 100 may convert a parameter value expressed in language A into a parameter value expressed in language B. A matching relationship between the parameter value expressed in language A and the parameter value expressed in language B may be stored in the memory 110 in the form of a lookup table. The electronic apparatus 100 may convert the parameter value expressed in language A into the parameter value expressed in language B.

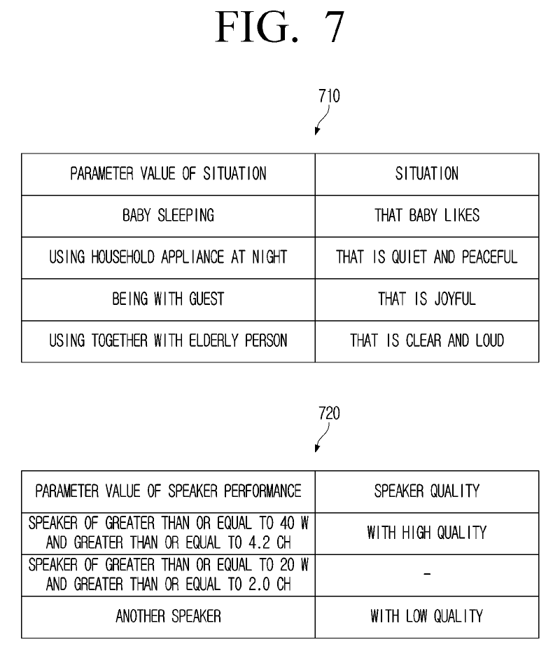

For example, the matching relationship between the parameter value expressed in language A and the parameter value expressed in language B may be like the one in the matching table 710, 720 illustrated in FIG. 7. Regarding an output environment of a sound set by the user, a parameter value such as “a baby is sleeping” expressed in language A may correspond to a parameter value such as “that baby likes” expressed in language B. Additionally, regarding speaker performance of an external apparatus, a parameter value such as “greater than or equal to 40 W and greater than or equal to 4.2 ch” expressed in language A may correspond to a parameter value such as “with high quality” expressed in language B.

The electronic apparatus 100 may generate a prompt by inputting the converted parameter value to the determined prompt format.

For example, a parameter value of a mood of a sound, set by the user, may be “clean”, a parameter value of a type of a sound may be an “alarm sound”, a parameter value of identification information of an external apparatus may be “washing machine”, a parameter value of music preferred by the user may be “song B of singer A”, a parameter value of an output environment of a sound may be “a baby is sleeping”, and a parameter value of speaker performance of an external apparatus may be “greater than or equal to 40 W and greater than or equal to 4.2 ch”.

At this time, a prompt generated by the electronic apparatus 100 may be like “a refreshing warning system sound which is joyful and similar with ‘B, A’ for microwave with high quality speaker”.

Meanwhile, the electronic apparatus 100 may obtain a prompt by using only part of obtained parameter values. Specifically, the electronic apparatus 100 may obtain a prompt by inputting only part of obtained parameter values to an input field of a prompt format.

For example, the electronic apparatus 100 may generate a prompt by inputting a parameter value, expect for a parameter value of music preferred by the user, to a determined prompt format. At this time, the prompt generated by the electronic apparatus 100 may be like “a refreshing warning system sound that baby likes for microwave with high quality speaker”.

When obtaining the prompt, the electronic apparatus 100 may obtain a sound in which a determined property is reflected by inputting the obtained prompt to the AI model (S550).

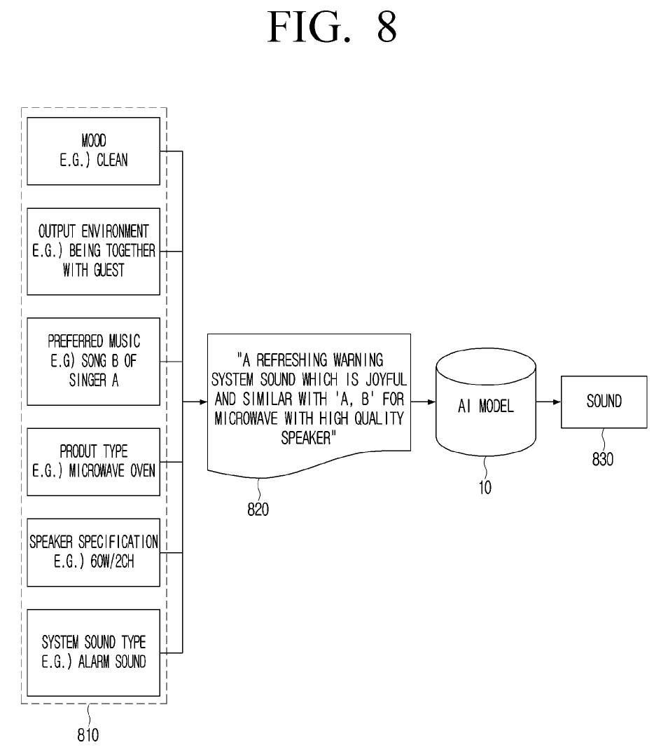

For example, referring to FIG. 8, the electronic apparatus 100 may obtain a prompt 820 by using an obtained parameter value 810, and generate a personalized sound 830 by inputting the obtained prompt 820 to the AI model 10. The AI model 10 may be a model that is trained to generate a sound corresponding to input data. That is, the AI model 10 may be a model that is trained to generate a sound having a property determined by a parameter value set by the user.

Meanwhile, in the case where a prompt is generated by using only part of the obtained parameter values, the electronic apparatus 100 may obtain a sound in which a property is reflected by inputting a parameter value separately to the AI model expect for part of the obtained parameter values. At this time, the electronic apparatus 100 may input part of parameter values set by the user, in the form of a separate feature vector rather than a prompt, to the AI model.

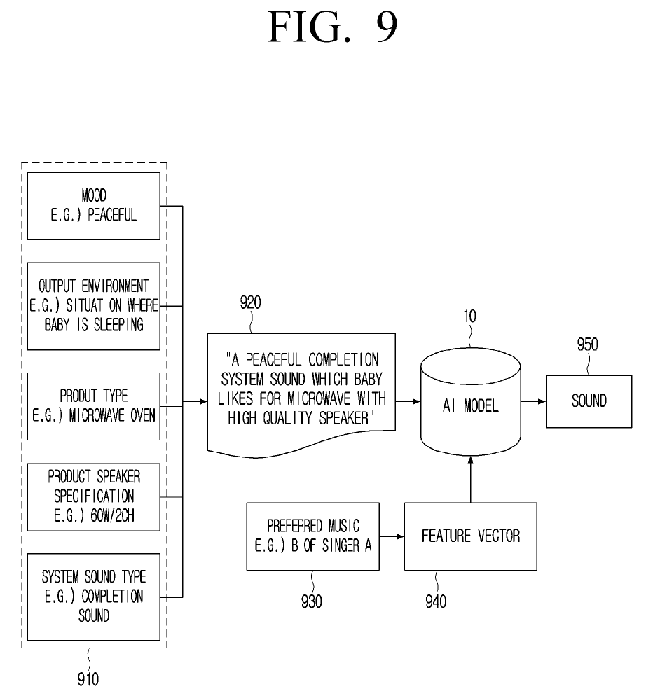

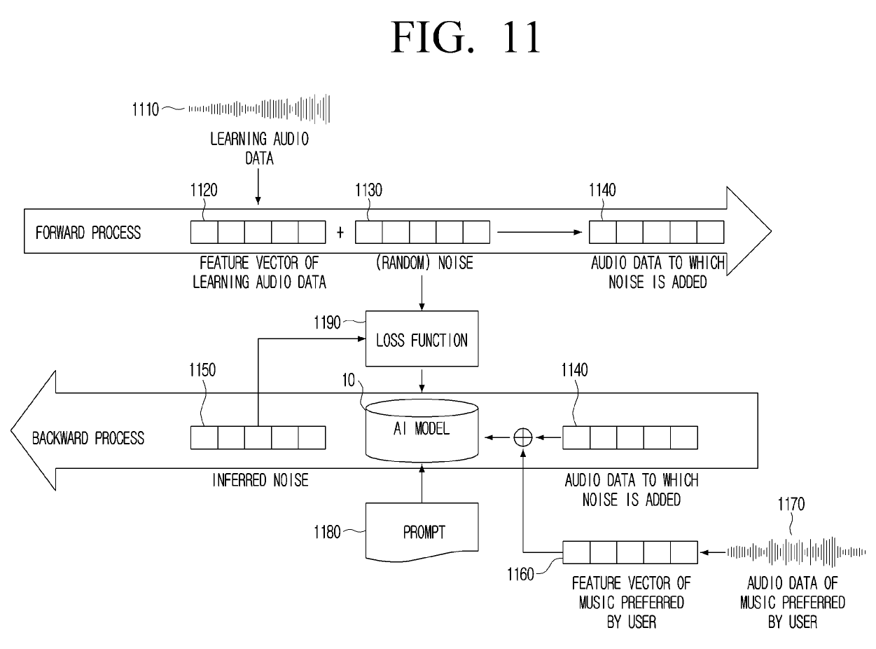

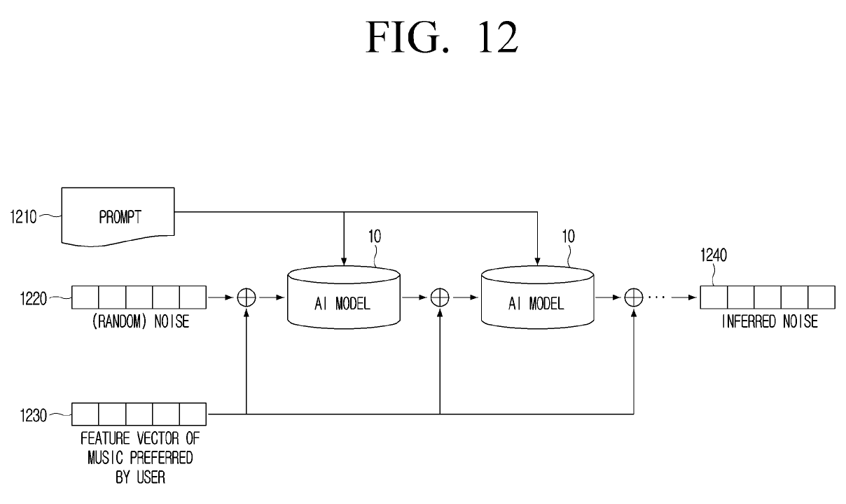

For example, referring to FIG. 9, the electronic apparatus 100 may generate a prompt 920 by using a parameter value 910 except for a parameter value 930 of music preferred by the user. The electronic apparatus 100 may convert the parameter value 930 of music preferred by the user into a feature vector 940 of music preferred by the user. At this time, the electronic apparatus 100 may generate a sound 950 by inputting the generated prompt 920 and the feature vector 940 of music preferred by the user together to the AI model 10. Meanwhile, outputting a sound directly by the AI model 10 is described with reference to FIGS. 8 and 9, but is described merely as one embodiment, and the electronic apparatus 100 may obtain an inferred noise by inputting the generated prompt 920 and the feature vector 940 of music preferred by the user together to the AI model 10, and obtain a sound 950 by using the inferred noise. More specific description in relation to this is provided hereinafter with reference to FIGS. 11 and 12.

Meanwhile, the electronic apparatus 100 may generate a prompt by using only part of obtained parameter values, and obtain a plurality of sounds by using the generated prompt. Additionally, the electronic apparatus 100 may select one of the plurality of obtained sounds by using the rest of the obtained parameter values.

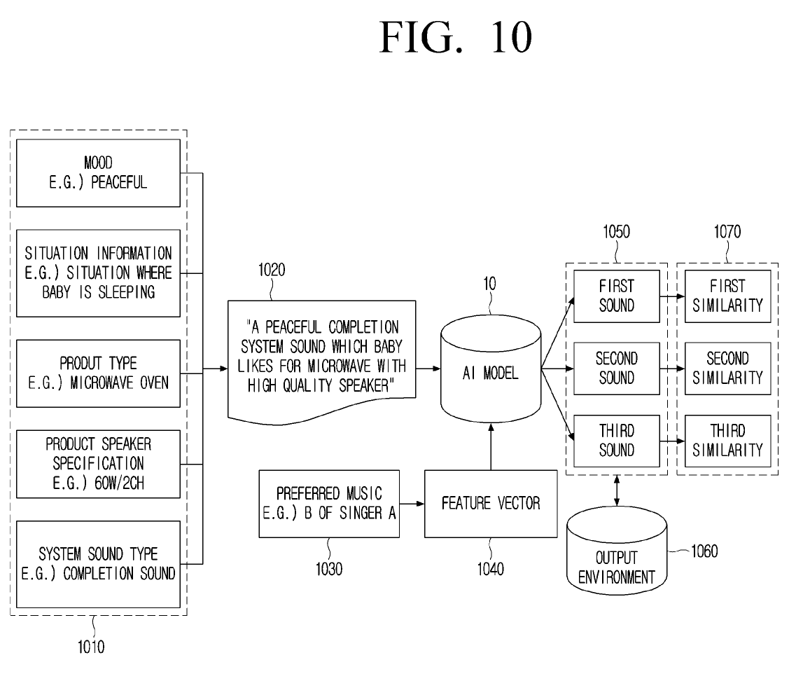

For example, referring to FIG. 10, the electronic apparatus 100 may obtain a prompt 1020 by using a parameter value 1010 except for a parameter value 1060 of the temporary environment in the output environment of a sound, among the obtained parameter values.

Further, the electronic apparatus 100 may obtain a plurality of sounds 1050 by inputting the obtained prompt 1020 and a feature vector 1040 of music 1030 preferred by the user to the AI model 10. At this time, the electronic apparatus 100 may also input the prompt 1020 only to the AI model 10 except for the feature vector 1040.

The electronic apparatus 100 may identify a sound corresponding to a set parameter value 1060 of the temporary environment, among the plurality of generated sounds 1050. The electronic apparatus 100 may identify a sound most similar to the parameter value of the temporary environment among the plurality of generated sounds.

Specifically, the electronic apparatus 100 may calculate a similarity 1070 between each of the plurality of sounds 1050 and the parameter value 1060 of the temporary environment. The electronic apparatus 100 may obtain a feature vector of each of the plurality of sounds, and obtain a feature vector of the parameter value of the temporary environment. The electronic apparatus 100 may calculate a cosine similarity between the feature vector of each of the plurality of sounds and the feature vector of the parameter value of the temporary environment. In one or more examples, the cosine similarity may be a metric used to measure the similarity between two vectors by calculating the cosine of the angle between them. The cosine similarity focuses on the direction or orientation of the vectors rather than their magnitude. The resulting cosine value ranges from -1 to 1, where 1 indicates perfect similarity, 0 indicates no similarity (vectors are orthogonal), and -1 indicates perfect dissimilarity (vectors are opposite in direction).

For example, in the case where the AI model generates three sounds, the electronic apparatus 100 may calculate a cosine similarity between a feature vector of a first sound and the feature vector of the parameter value of the temporary environment, calculate a cosine similarity between a feature vector of a second sound and the feature vector of the parameter value of the temporary environment, and calculate a cosine similarity between a feature vector of a third sound and the feature vector of the parameter value of the temporary environment. Meanwhile, the above method of calculating the similarity 1070 between each of the plurality of sounds 1050 and the parameter value 1060 of the temporary environment by using the cosine similarity is described merely as one embodiment, and certainly, another method may be used to calculate the similarity 1070 between each of the plurality of sounds 1050 and the parameter value 1060 of the temporary environment.

The electronic apparatus 100 may identify a feature vector of a greatest cosine similarity to the feature vector of the parameter value of the temporary environment, among the feature vectors associated with each of the plurality of obtained sounds.

In the case where a sound is generated by using a prompt as described in the above-described method, the electronic apparatus 100 may transmit the generated sound to the terminal apparatus 200. The terminal apparatus 200 may transmit the generated sound to the external apparatus 300.

In particular, in the case where a plurality of sounds is generated and one of the plurality of sounds is identified, the electronic apparatus 100 may transmit the identified sound to the terminal apparatus 200.

In the case where conditions for outputting the received sound are satisfied, the external apparatus 300 may output the received sound. For example, when power is turned on, the external apparatus 300 may output a sound indicating that the power of the external apparatus 300 is turned on. At this time, the output sound may be a sound personalized for the user.

Meanwhile, the AI model according to the disclosure may be implemented as a diffusion model. That is, the AI model may be implemented as a generative AI model generating output data from data including a noise under a condition of input data.

The electronic apparatus 100 may train the AI model to generate a sound corresponding to a prompt under a condition of the prompt that is input data.

Description in relation to this is provided with reference to the drawings hereinafter.

FIG. 11 is a view provided to explain how an electronic apparatus trains an AI model according to one embodiment.

The electronic apparatus 100 may obtain a learning dataset. Referring to FIG. 11, the learning dataset may include data in which a prompt 1110 and audio data 1120 are paired. Alternatively, the learning dataset may include data in which the prompt 1110, the audio data 1120 and the feature vector 1160 of music 1170 preferred by the user are paired.

At this time, first audio data 1120 may be a feature vector of a first audio signal 1110. Learning data may include audio data. Alternatively, the electronic apparatus 100 may also obtain audio data by extracting a feature of an audio signal included in the learning data.

Referring to FIG. 11, the electronic apparatus 100 may obtain second audio data 1140 in which a noise 1130 is added n times by performing a forward process of randomly adding the noise 1130 consecutively n times to the first audio data 1120 with no noise.

The electronic apparatus 100 may train the AI model 10 to perform a backward process of inferring the first audio data 1120 from which the noise 1130 is removed, from the second audio data 1140 to which the noise is added n times.

The term “forward process” may be replaced with a “diffusion process”, and the term “backward process” may be replaced with a “reverse process”.

Specifically, the noise 1130 added to the first audio data 1120 may be a Gaussian noise based on a Gaussian distribution. A size and distribution of a noise may be adjusted to optimize performance of an AI model during a training process.

That is, the electronic apparatus 100 may add the noise 1130 consecutively to the first audio data 1120 such that a distribution of data to which a noise is added may be based on the Gaussian distribution. Specifically, the electronic apparatus 100 may obtain the second audio data 1140 by adding a noise to the first audio data 1120 such that an average of the second audio data may become close to 0 while a distribution of the second audio data may become close to 1.

The electronic apparatus 100 may infer audio data from which a noise is removed, from the second audio data 1140. That is, the AI model may infer a noise 1150 included in the second audio data 1140. The electronic apparatus 100 may infer the first audio data by removing the noise inferred by the AI model 10 from the second audio data 1140.

The electronic apparatus 100 may train the AI model 10 based on a loss function 1190 including a difference between the noise 1130 added to the first audio data 1120 and the noise 1150 inferred from the second audio data 1140. That is, the electronic apparatus 100 may train the AI model 10 such that the difference between the noise 1130 added to the first audio data 1120 and the noise 1150 inferred from the second audio data 1140 may become small.

Specifically, the electronic apparatus 100 may train the AI model 10 to infer an n^{th} noise added from audio data 1140 to which the noise is added n times.

At this time, the electronic apparatus 100 may train the AI model 10 to infer the n^{th} noise added by inputting audio data to which the noise is added n times, the prompt, and the feature vector of music preferred by the user. The electronic apparatus 100 may obtain audio data to which the noise is added n-1 times by removing the n^{th} noise added from the audio data to which the noise is added n times. Meanwhile, when the AI model 10 is trained, the feature vector of music preferred by the user may be omitted. That is, the electronic apparatus 100 may train the AI model to infer the nth noise added by inputting the audio data to which the noise is added n times and the prompt.

That is, during a training process, the electronic apparatus 100 may train an AI model under a condition of a prompt paired with audio data. Alternatively, during a training process, the electronic apparatus 100 may train an AI model under a condition of a prompt paired with audio data and a feature vector of music preferred by the user.

Accordingly, in an inference step of the AI model, the AI model may infer an n^{th} noise added from audio data to which a noise is added n times under a condition of a prompt and a feature vector of music preferred by the user. At this time, the feature vector of music preferred by the user may be omitted. That is, the AI model may infer the n^{th} noise added from the audio data to which the noise is added n times under a condition of a prompt.

The inference process of the AI model according to the disclosure is described specifically with reference to FIG. 12.

FIG. 12 is a view provided to explain a process of generating a sound by using an AI model according to one embodiment.

Referring to FIG. 12, the electronic apparatus 100 may input a prompt 1210 and a randomly generated noise 1220 to the AI model 10.

At this time, the electronic apparatus 100 may concatenation-calculate the noise 1220 and a feature vector 1230 of music preferred by the user, and input a resultant value of the concatenation-calculation together with the prompt 1210 to the AI model 10.

The AI model 10 may be a model to which a cross-attention mechanism for training a correlation between the resultant value input of the concatenation-calculation and the prompt 1210 is applied.

The AI model may infer an added noise from audio data to which a noise is added under a condition of an input prompt and feature vector. In particular, the electronic apparatus 100 may infer a noise by inputting the prompt 1210, the noise 1220 and the feature vector 1230 of music preferred by the user to the AI model. Herein, the electronic apparatus 100 may infer the noise 1240 by repeating the above-described operation a preset number of times or a number of times a change in the inferred noise is minimized, as illustrated in FIG. 12. Additionally, the electronic apparatus 100 may obtain a sound by removing the inferred noise 1240 from the noise 1220 input to the AI model 10.

Meanwhile, the electronic apparatus 100 according to the disclosure may also infer a noise at a time, without repeating the operation of removing a noise a preset number of times as described above. That is, the AI model 10 may infer a noise included in audio data to which the noise is added, at a time. At this time, the electronic apparatus 100 may obtain a sound from which the noise is removed by removing the noise inferred by the AI model 10 from the input noise.

Meanwhile, the electronic apparatus 100, as described above, may generate a personalized sound, but this is described merely as one embodiment, and the terminal apparatus 200 or the external apparatus 300 may generate and output a personalized sound.

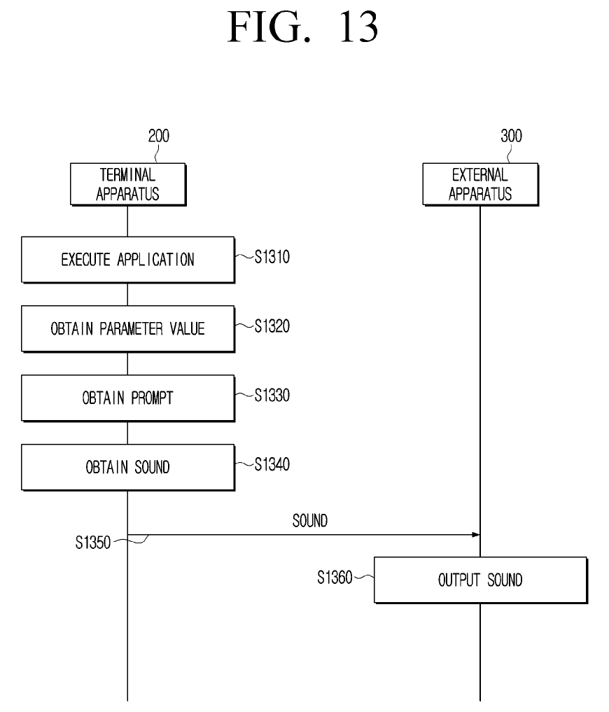

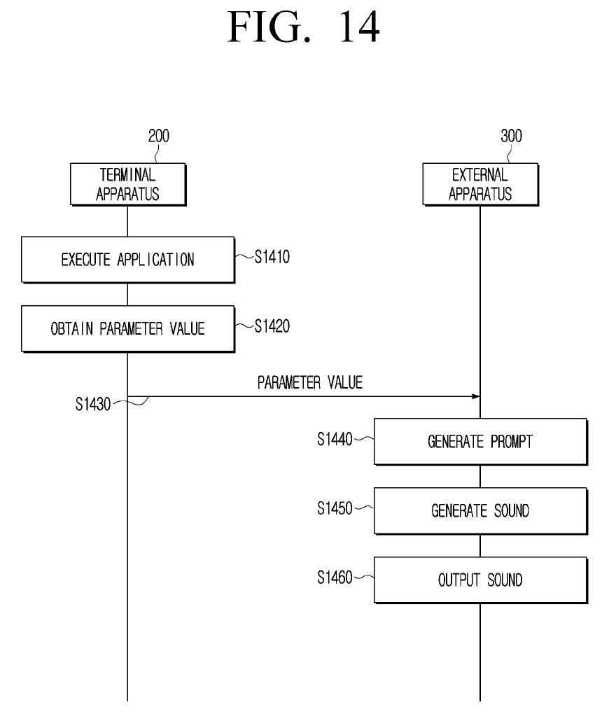

Description in relation to this is provided with reference to FIGS. 13 and 14.

FIG. 13 is a sequence diagram provided to explain operations of an electronic apparatus, a terminal apparatus and an external apparatus according to one embodiment.

Referring to FIG. 13, the terminal apparatus 200 may execute an application (S1310). The terminal apparatus 200 may obtain a parameter value through the executed application (S1320). The operations of S1310 and S1320 may be the same as the operations of S510 and S520 described with reference to FIG. 5.

The terminal apparatus 200 may generate a prompt by using the obtained parameter value (S1330). The terminal apparatus 200 may obtain a sound by using the generated prompt (S1340). The operations of the terminal apparatus 200 in S1330 and S1340 may be the same as the operations of the electronic apparatus 100 in S540 and S550 described with reference to FIG. 5.

The terminal apparatus 200 may transmit the obtained sound to the external apparatus 300 (S1350). In the case where conditions for outputting the received sound are satisfied, the external apparatus 300 may output the received sound (S1360).

FIG. 14 is a sequence diagram provided to explain operations of an electronic apparatus, a terminal apparatus and an external apparatus according to one embodiment.

Referring to FIG. 14, the terminal apparatus 200 may execute an application (S1410). The terminal apparatus 200 may obtain a parameter value through the executed application (S1420). The operations of S1410 and S1420 may be the same as the operations of S510 and S520 described with reference to FIG. 5.

The terminal apparatus 200 may transmit the obtained parameter value to the external apparatus 300 (S1430).

The external apparatus 300 may obtain a prompt by using the obtained parameter value (S1440). The external apparatus 300 may obtain a personalized sound by using the obtained prompt (S1450). In the case where conditions for outputting the obtained sound are satisfied, the external apparatus 300 may output the obtained sound (S1460).

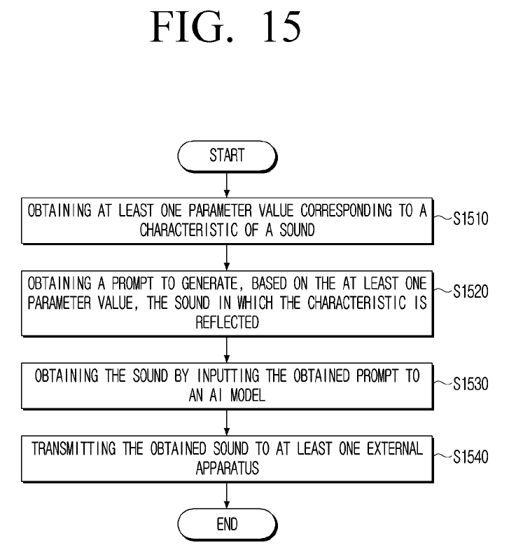

FIG. 15 is a flowchart provided to explain a control method of an electronic apparatus according to one embodiment.

Referring to FIG. 15, the electronic apparatus 100 may obtain at least one parameter value corresponding to a characteristic of a sound (S1510).

The parameter value may include at least one of an output environment of a sound, a mood of a sound, a type of a sound, music preferred by the user, and a type of an external apparatus.

The parameter value from among the at least one parameter value comprises a value based on at least one of a characteristic of an environment to which the sound is output, a vibe of the sound, a type of the sound, information on music preferred by a user, identification information corresponding to an external apparatus by which the sound is output, or an event to be sensed.

The electronic apparatus 100 may obtain information on music preferred by the user in link with a music application installed in a terminal apparatus of the user. Alternatively, the electronic apparatus 100 may obtain, from a music application executed in an external apparatus, the information on music preferred by the user.

The electronic apparatus 100 may obtain a prompt to generate a sound in which a characteristic is reflected (S1520).

The electronic apparatus 100 may obtain a sound by inputting the obtained prompt to an AI model (S1530).

According to one embodiment, the electronic apparatus 100 may obtain a feature vector of music preferred by the user based on the information on music preferred by the user. Additionally, the electronic apparatus 100 may obtain a sound by inputting the prompt and the feature vector of music preferred by the user to the AI model.

According to one embodiment, the electronic apparatus 100 may obtain a plurality of sounds in which a property is reflected. Additionally, the electronic apparatus 100 may identify a similarity between a feature vector of each of the plurality of sounds and a feature vector corresponding to a situation of the user. Further, the electronic apparatus 100 may identify a sound having a feature vector most similar to the feature vector corresponding to a situation of the user. Furthermore, the electronic apparatus 100 may transmit the identified sound to the at least one external apparatus.

According to one embodiment, the electronic apparatus 100 may obtain a sound by removing a noise from data including the noise following a Gaussian distribution under a condition of a generated prompt.

The electronic apparatus 100 may transmit the obtained sound to the at least one external apparatus (S1540).

According to one embodiment, the electronic apparatus 100 may transmit the obtained sound to the at least one external apparatus, based on the event being sensed.

Specifically, when an event is sensed, the electronic apparatus 100 may obtain a sound that reflects a property corresponding to the sensed event. Thereafter, the electronic apparatus 100 may transmit the sound corresponding to the sensed event to an external apparatus.

In one embodiment, the electronic apparatus 100 may sense an event such as a "visitor arrival." The electronic apparatus 100 may identify that a visitor has arrived when a voice other than a voice registered to the electronic apparatus 100 is sensed. Alternatively, the electronic apparatus 100 may identify a visitor arrival when voices of multiple persons are sensed. The electronic apparatus 100 may transmit a sound corresponding to the sensed event to the external apparatus.

The electronic apparatus 100 may generate a prompt using a parameter value corresponding to the sensed event, and may obtain a sound corresponding to the sensed event using the generated prompt. In one embodiment, when an event is sensed, the electronic apparatus 100 may generate a sound corresponding to the sensed event and transmit the generated sound to the external apparatus. For example, when an event of "visitor arrival" is sensed, the electronic apparatus 100 may generate a sound corresponding to the sensed "visitor arrival" event and transmit it to the external apparatus.

In another embodiment, the electronic apparatus 100 may generate and store a sound corresponding to the sensed event, and may transmit the stored sound to the external apparatus when the event is subsequently sensed. For example, the electronic apparatus 100 may generate and store a sound corresponding to the sensed event of "visitor arrival," and may transmit the stored sound to the external apparatus when the event is later sensed.

Accordingly, the electronic apparatus 100 may provide a sound corresponding to a sensed event, thereby offering a personalized sound experience suitable for the user's environment.

According to one embodiment, in the case where the output environment of a sound is sensed, the obtained sound may be transmitted to the external apparatus such that the external apparatus may output the obtained sound.

According to one embodiment, the electronic apparatus 100 may obtain information on speaker performance of a plurality of external apparatuses. Additionally, the electronic apparatus 100 may transmit the obtained sound to an external apparatus of which speaker performance is greater than speaker performance of the other external apparatus.

According to one embodiment, in the case where conditions for outputting the obtained sound are satisfied, the electronic apparatus 100 may transmit the obtained sound to the at least one external apparatus placed in a space where the terminal apparatus of the user is placed, among the plurality of external apparatuses.

Various embodiments are respectively described above, but each of the embodiments may not be necessarily implemented individually, but may be coupled entirely or partially with at least another embodiment and implemented together with the at least another embodiment in one product.

Meanwhile, the term “unit” or “module” set forth herein may include a unit comprised of hardware, software or firmware, and for example, may be used interchangeably with terms such as logic, a logic block, a component or a circuit and the like. The term “unit” or “module” may be an integrally constituted component or a minimum unit performing one or more functions or part thereof. For example, the module may be comprised of an application-specific integrated circuit (ASIC).

The embodiments according to the disclosure may be implemented with software including instructions stored in a storage medium readable by a machine (e.g., a computer). The machine, as a device capable of calling the stored instructions from the storage media and operating according to the called instructions, may include an electronic apparatus (100) according to the disclosed embodiments. When the instructions are executed by a processor, the processor may perform functions corresponding to the instructions directly or by using other elements under the control of the processor. The instructions may include a code generated or executed by a compiler or an interpreter. The machine-readable storage medium may be provided in the form of a non-transitory storage medium. Herein, the term “non-transitory” only means that the storage medium includes no signal and is tangible, while the term does distinguish semi-permanent or temporary storage of data in the storage medium.

According to one or more embodiments, the methods according to the embodiments set forth herein may be provided in a computer program product. The computer program product may be exchanged between a seller and a purchaser as a commodity. The computer program product may be distributed in the form of a machine-readable storage medium (e.g., compact disc read only memory (CD-ROM)), or distributed online through an application store (e.g., Play Store^{TM}). In the case of online distribution, at least part of the computer program product may be stored at least temporarily, or generated temporarily in a storage medium such as a server of a manufacturer, a server of an application store, or memory of a relay server.

Each of the elements (e.g., a module or a program) according to the embodiments may be comprised of a single entity or a plurality of entities, and some of the corresponding sub elements described above may be omitted, or another sub element may be further included in the embodiments. Alternatively or additionally, some of the elements (e.g., modules or programs) may be integrated into one entity to perform identical or similar functions performed by each corresponding element prior to the integration. Operations performed by a module, a program, or another element, according to the embodiments, may be executed sequentially, in parallel, repetitively, or heuristically, or at least part of the operations may be executed in a different order, may be omitted, or may add a different operation.

What is claimed is:

1. An electronic apparatus comprising:
at least one processor; and
memory storing at least one instruction,
wherein the at least one instruction, when executed by the at least one processor individually or collectively, cause the electronic apparatus to:
obtain at least one parameter value corresponding to a characteristic of a sound;
obtain a prompt to generate, based on the at least one parameter value, the sound in which the characteristic is reflected;
obtain the sound by inputting the obtained prompt to an AI model; and
transmit the obtained sound to at least one external apparatus.

2. The electronic apparatus as claimed in claim 1, wherein a parameter value from among the at least one parameter value comprises a value based on at least one of a characteristic of an environment to which the sound is output, a vibe of the sound, a type of the sound, information on music preferred by a user, identification information corresponding to an external apparatus by which the sound is output, or an event to be sensed.

3. The electronic apparatus as claimed in claim 2, wherein the at least one instruction, when executed by the at least one processor individually or collectively, causes the electronic apparatus further to:
based on the event being sensed, transmit the obtained sound to the at least one external apparatus.

4. The electronic apparatus as claimed in claim 2, wherein the at least one instruction, when executed by the at least one processor individually or collectively, causes the electronic apparatus to:
obtain, from a music application executed in an external apparatus, the information on music preferred by the user.

5. The electronic apparatus as claimed in claim 4, wherein the at least one instruction, when executed by the at least one processor individually or collectively, causes the electronic apparatus to:
obtain a feature vector of music preferred by the user based on the information on music preferred by the user; and
obtain the sound by inputting the prompt and the feature vector of music preferred by the user to the AI model.

6. The electronic apparatus as claimed in claim 1, wherein the at least one instruction, when executed by the at least one processor individually or collectively, causes the electronic apparatus to:
obtain a plurality of sounds in which the characteristic is reflected;
determine a similarity score between a feature vector of each of the plurality of sounds and a feature vector corresponding to a situation of a user;
identify a sound from the plurality of sounds having a highest similarity score; and
transmit the identified sound to the at least one of external apparatus.

7. The electronic apparatus as claimed in claim 1, wherein the at least one instruction, when executed by the at least one processor individually or collectively, causes the electronic apparatus to:
obtain the sound by removing a noise from data based on a Gaussian distribution.

8. The electronic apparatus as claimed in claim 1, wherein the at least one instruction, when executed by the at least one processor individually or collectively, causes the electronic apparatus to:
obtain information on speaker performance of a plurality of external apparatuses; and
transmit the obtained sound to an external apparatus of which speaker performance is greater than speaker performance of the other external apparatuses.

9. The electronic apparatus as claimed in claim 1, wherein the at least one instruction, when executed by the at least one processor individually or collectively, causes the electronic apparatus to:
based on a condition for outputting the obtained sound being satisfied, transmit the obtained sound to the at least one external apparatus among a plurality of external apparatuses, the at least one external apparatus being placed in a space in which a terminal apparatus of a user is placed.

10. A control method of an electronic apparatus, the method comprising:
obtaining at least one parameter value corresponding to a characteristic of a sound;
obtaining a prompt to generate, based on the at least one parameter value, the sound in which the characteristic is reflected;
obtaining the sound by inputting the obtained prompt to an AI model; and
transmitting the obtained sound to at least one external apparatus.

11. The method as claimed in claim 10, wherein a parameter value from among the at least one parameter value comprises a value based on at least one of a characteristic of an environment to which the sound is output, a vibe of the sound, a type of the sound, information on music preferred by a user, identification information corresponding to an external apparatus by which the sound is output, or an event to be sensed.

12. The method as claimed in claim 11, wherein the transmitting the obtained sound to at least one external apparatus includes, based on the event being sensed, transmitting the obtained sound to the at least one external apparatus.

13. The method as claimed in claim 11, wherein the obtaining at least one parameter value corresponding to a characteristic of a sound includes obtaining, from a music application executed in an external apparatus, the information on music preferred by the user.

14. The method as claimed in claim 13, wherein the method further comprises:
obtaining a feature vector of music preferred by the user based on the information on music preferred by the user, and
wherein the obtaining a sound includes obtaining the sound by inputting the prompt and the feature vector of music preferred by the user to the AI model.

15. The method of claim 10, wherein the obtaining a sound includes obtaining a plurality of sounds in which the characteristic is reflected,
wherein the method further comprises:
determining a similarity score between a feature vector of each of the plurality of sounds and a feature vector corresponding to a situation of a user, and
identifying a sound from the plurality of sounds having a highest similarity score, and
wherein the transmitting the obtained sound to the external apparatus includes transmitting the identified sound to the at least one of external apparatus.

16. A non-transitory computer readable medium having instructions stored therein, which when executed by a processor in an electronic apparatus, cause the processor to execute a method comprising:
obtaining at least one parameter value corresponding to a characteristic of a sound;
obtaining a prompt to generate, based on the at least one parameter value, the sound in which the characteristic is reflected;
obtaining the sound by inputting the obtained prompt to an AI model; and
transmitting the obtained sound to at least one external apparatus.

17. The non-transitory computer readable medium as claimed in claim 16, wherein a parameter value from among the at least one parameter value comprises a value based on at least one of a characteristic of an environment to which the sound is output, a vibe of the sound, a type of the sound, information on music preferred by a user, identification information corresponding to an external apparatus by which the sound is output, or an event to be sensed.

18. The non-transitory computer readable medium as claimed in claim 17, wherein the transmitting the obtained sound to at least one external apparatus includes, based on the event being sensed, transmitting the obtained sound to the at least one external apparatus.

19. The non-transitory computer readable medium as claimed in claim 17, wherein the obtaining at least one parameter value corresponding to a characteristic of a sound includes obtaining, from a music application executed in an external apparatus, the information on music preferred by the user.

20. The non-transitory computer readable medium as claimed in claim 19, wherein the method further comprises:
obtaining a feature vector of music preferred by the user based on the information on music preferred by the user, and
wherein the obtaining a sound includes obtaining the sound by inputting the prompt and the feature vector of music preferred by the user to the AI model.
